(19) United States
(12) Patent Application Publication
(10) Pub. No.: US 2009/0146440 A1
(43) Pub. Date: Jun. 11, 2009

(54) Apparatus and Method for Gripping, Holding and Releasing Objects That Can Be Penetrated

(76) Inventors: Jan O. Buljo, Hundhamaren (NO); Reidar Hovtun, Borsa (NO)

Correspondence Address: WENDEROTH, LIND & PONACK, L.L.P., 1030 15th Street, N.W.,, Suite 400 East, Washington, DC, 20005-1503, US

(21) Appl. No.: 12/083,682

(22) PCT Filed: Oct. 20, 2006
(86) PCT No.: PCT/NO2006/000368

§ 371 Date: Jun. 27, 2008

(30) Foreign Application Priority Data
Oct. 21, 2005 (NO) 2005 4879

(51) Int. Cl. B25J 15/08; B25J 15/10; B65G 47/90; B66C 3/04

(52) U.S. Cl. 294/61; 901/39; 901/37

(57) ABSTRACT

The present invention concerns an apparatus for gripping, holding and releasing objects (30) that can be penetrated. The apparatus includes at least two needles (1, 2) with a central axis in the longitudinal direction of the needle placed at a distance from each other. At least one drive unit is connected to the needles (1, 2) for driving these between an extended and a retracted position. At least one of the central axes of the needles forms a part of a circle when this needle is in an extended position. Furthermore it is described a method to grip, hold and release objects (30) that can be penetrated.

The present invention concerns an apparatus and a method for handling non-rigid objects as for instance fillet of fish or meat. A needle gripper grips an object by piercing needles into the object according to a particular pattern and in defined directions. Thereby it is achieved a fixation between the needle gripper, or the tool and the object. Furthermore it is described a method for gripping, holding and releasing objects.

Handling some products mechanically is in some cases complicated and such products are therefore normally handled manually. Examples of products that can be difficult to handle are fillets of fish, fillets of poultry, or other smaller pieces of meat. The manual handling is for instance performed in connection with packing. Manual packing has several disadvantages. The first disadvantages is obvious, and is connected to the manual work involved that otherwise could have been done mechanically. Another problem is that such manual operations frequently results in errors. During packing operations, for instance when feeding fillet pieces in deep drawers or vacuum packing machines, mistakes frequently occurs because the operators spills liquid on the welding face where the upper and lower foil is welded around the products, such that loss of vacuum occurs. Today therefore a number of packs must be reopened and repacked. This forms delays for the operator or the operators at the packing machine. By using a robot and a gripper according to the invention, the machines can be controlled in a way such that these problems are avoided.

Similar problems are found in many areas, in particular within the food industry. Needle grippers for handling soft and easily penetratable materials is for instance shown from JP 56136729A that concerns an apparatus for handling rod shaped foam bodies for noise reduction or cushions, where is a group of parallel needles is led into the body of foam, and then another group of parallel needles is inserted into the foam body for thereafter to be able to move the foam body from an element where the foam body is secured.

The apparatus for gripping, holding and releasing objects that can be penetrated particularly articles of food that can be penetrated comprises at least two needles. The needles may have pointed tips. An actuator or drive unit is connected to the needles to drive these between an extended and a retracted position. The needles are placed in guides and each needle is curved. The longitudinal, central axis of the needles forms a part of a circle with geometric central axes. The needles are adapted to be driven between an extended and a retracted position along circular paths defined by the central axis of each needle respectively. The pointed tips points towards each other when these are partly or completely extended.

The at least one of the needles whose axis forms a part of a circle may move between the extended position and the retracted position along a path that is substantially coinciding with the central axis of this needle.

The at least two needles may include central axes that forms parts of circles when these are in an extended position, and the paths of motion of the at least two needles may be coinciding with the respective central axis of the needles.

The needles may be placed in separate planes, and these planes may be parallel.

The at least two needles may be placed in the same plane.

The at least two needles may be adapted to be driven between an extended and a retracted position along each circular path that each defines axes of rotation, and during extension of the needles these may be led along the circular path in each direction about the axis of rotation.

The geometric axes of rotation of the needles may be coinciding.

The apparatus according to the invention may furthermore include at least one cylinder with a central axis and a dually curved internal face. A piston with a dually curved outer face is in this case placed in each cylinder, and is connected to a needle such that the piston and the cylinder forms the drive unit and may drive the needle between an extended position and a retracted position by imposing a pressure medium in the cylinder. The piston may have a ball shape, have a ball shape with a recessed central circumference for a gasket or may be in the form of a short torus.

The central axis of the at least one cylinder may be coinciding with the central axis of the at least one needle.

Each cylinder may be formed as a module including at least two module elements with parallel, plane sides and borings for leading a pressure medium. The module elements may be placed in a housing such that a number of modules corresponds to the number of needles that should be used. The module elements may be assembled, side by side with the borings for leading a pressure medium adjoining each other.

Furthermore the invention defines a gripping element that may include at least two gripping devices and may include a plate for being secured to a robot, and a controllable linear actuator for each apparatus secured in each apparatus and in the plate such that the gripping element may be adapted to the shape of an object that is to be lifted.

A method for gripping, holding and releasing objects that can be penetrated may include placing the plate for being secured in a robot above the object that is to be handled. The apparatuses may also be led towards the object that is to be handled. The apparatuses may be controlled with the linear actuators to a position adjoining the object that is to be handled, and at least two needles may simultaneously be driven from the retracted position and to the extended position inside the object. The object is then maneuvered to a desired location and is released by leading the needles to the retracted position.

The needles are previously described to be situated in parallel planes and to move towards each other. However the needles could also be configured towards each other in the same plane. In this embodiment the needles will preferably be placed at a distance from each other such that they do not collide. When the needles are placed in different planes, these may be extended such that they cross or overlap each other. The housing for securing the drive assemblies may include a rigid underside such that the needles may be led in and out of the housing or the housings between the extended position and the retracted position.

The apparatus may for instance include four needles, placed in four parallel planes, when these are in their extended position. The distance between the needles may be varied to be adapted to the object that it is to be lifted.

The housings may include borings that forms guides for the needles.

The housings may include a curved surface towards the element that is to be lifted.

The apparatus may be adapted for being secured to a robot via a fixing element.

The drive units may be pneumatic cylinders and the borings in the module elements and in the end pieces may create manifolds for pressurized air connected to source for pressurized air and to the pneumatic drive units.

The needles may be driven simultaneously between the extended position and the retracted position.

A method for moving objects that can be penetrated, for instance fillets of fish may include to provide a fillet on a conveyor belt, detect a position of the fillet with a camera, optical sensors, pressure elements or similar element, transferring position data to a micro processor controlling a robot with an apparatus according to the invention, lead the apparatus above the fillet and lead the underside of the apparatus abutting the fillet by means of the robot, lead needles simultaneously into the fillet, lift the fillet by means of the robot via the apparatus, place the fillet in a desired location by the robot and retract the needles substantially simultaneously out of the fillet to release this on the desired location. Such a system will additionally have to include a source for pressurized fluid, computer controlled electrical valves and a suitable piping system between the source of pressurized fluid, the valves and the apparatus.

It will normally be desirable that the fillet not is displaced in relation to the apparatus when the needles are inserted, and it is therefore a point that the forces the needles imposes on the fillet equalizes each other such that the fillet remains stationary in relation to the apparatus during the gripping and releasing operation. The needles may also be controlled such that they impose a certain strain in the fillet when the needles are inserted.

The invention may for instance be used for feeding fillets in freezers in connection with a robot and a system for identifying the location of the fillet pieces for instance on a conveyer belt. A camera or photo cells may for instance be used for identifying the location of the fillet pieces. Use of needle grippers may also be used for handling round fish, for instance for feeding a filleting machine. Similar needs are also within the salt- and dried cod industry where a needle gripper may be used. Within the meat industry it is also a need for automatization of the handling operations either it concerns the sectors poultry, sheep, goat, pork or nolt.

The needle gripper according to the invention may be used for handling all objects that not have the quality considerably affected negatively when the object is inflicted with needle stings. The needle gripper is in other words not suitable for handling objects where the quality is reduced by needle stings, or where the objects may include hard portions inside the object that may destroy the needles.

Accordingly fillet products without considerable remainders of bones of fish, poultry, sheep and goat, pork or nolt are relevant objects to be handled by a needle gripper. This also concerns other objects, for instance components of soft foam, of soft polymers or other soft materials that may handle the needle stings. The needle gripper may also be used for objects that include harder components such as bone etc. if the needles are made with sufficient strength.

### SHORT DESCRIPTION OF THE ENCLOSED DRAWINGS

FIG. 1 is a perspective view of an embodiment of a needle gripper, secured to a robot;

FIG. 2 is a view of the needle gripper shown on FIG. 1, where the needle gripper is partly disassembled;

FIG. 3 is perspective view of a needle gripper according to the shown embodiment;

FIG. 4 is an exploded view of the needle gripper shown on the other figures;

FIG. 5 is a perspective view of the needle gripper shown on the other figures, partly disassembled; and

FIG. 6 is side elevation of an alternative to the apparatus shown on FIG. 1 where it is shown how the apparatus may be adapted to objects of various shape in that the entire element is rotated.

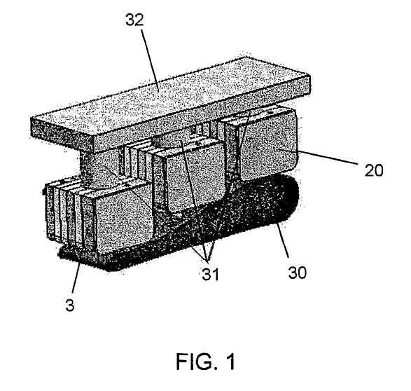

FIG. 1 shows an embodiment of a needle gripper according to the invention, designed for handling for instance fillet products. The figure shows an object or fish fillet 30 that is to be lifted by three needle grippers secured to plate 32 for being secured in a robot, or another actuator. Each of the three needle grippers are secured to an actuator or fixing element 31 for adjusting the location of the needle gripper in relation to the fixing plate 32 and to adapt the grippers to the shape of the fillet 30 that is to be lifted. The fixing element 31 may be designed as linear actuator elements that may have variable length. Such elements may be hydraulic or pneumatic cylinders, be designed with electric actuators etc., well known within the area. The task of the fixing elements is to adapt the distance between the fillet 30 or the object that is to be lifted and the needle gripper, such that the location of the needle gripper is adapted to the shape of the fillet.

The end plates 20 and the housing 3 of the needle gripper are clearly shown on the figure. The fixing plate 32 will typically be a bracket for fixing the needle gripper to a robot arm and may be made of stainless steel. The housing 3 of the needle gripper may for instance be made of high density polyethylene (PHED) that is a plastic material that is to a considerable degree used within the food industry. The material withstands normally used detergent and has a very limited absorption of humidity.

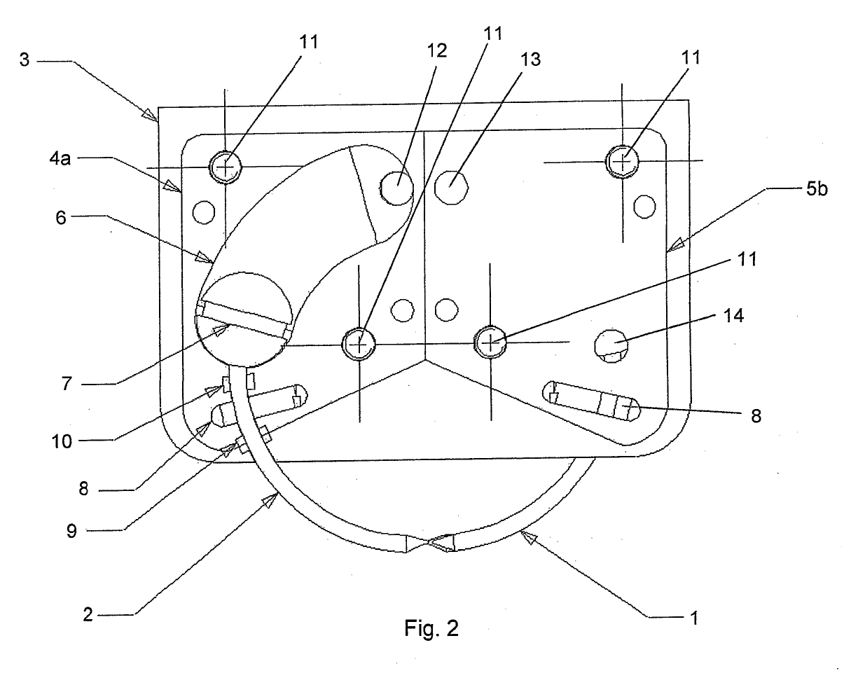

From FIG. 2 it is shown a partly disassembled needle gripper, such that the elements of the needle gripper are clearly shown.

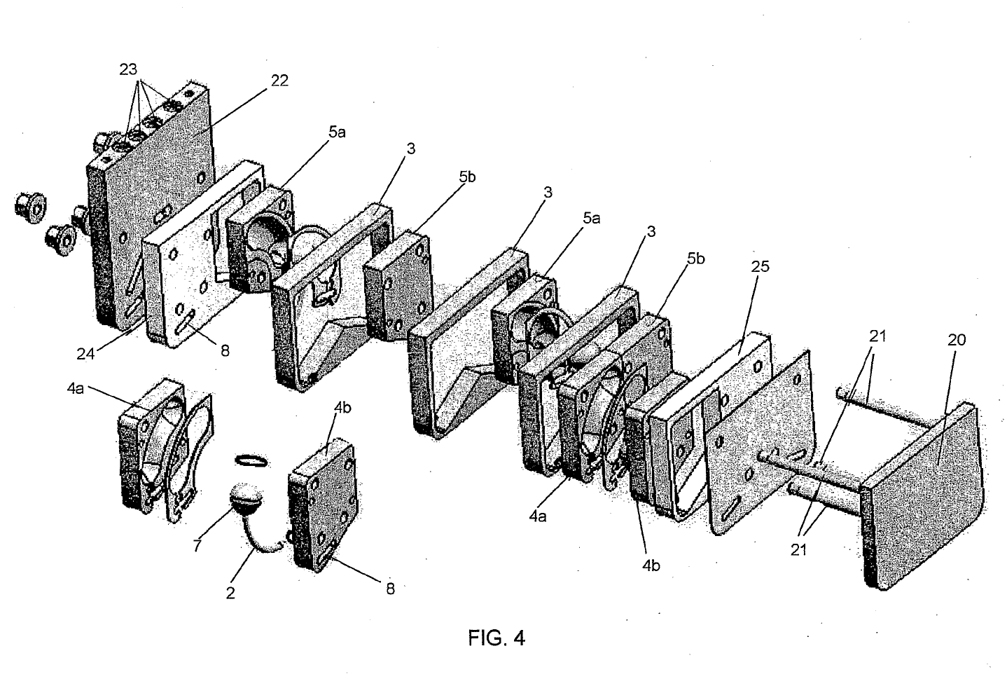

In the shown embodiment of the needle gripper, it is assembled of a number of modules that are placed on top of each other, such that the number of needles and size of the gripper can be varied as needed. FIG. 2 shows such a module, and how a housing 3 holds a left module part 4a and a right module part 5b in position. To provide a complete cylinder that can be said to form a module, the left and the right module parts each of them must include two parts (4a, 4b and 5a, 5b shown on FIG. 4 respectively). The back side of the left module part 4a that not is shown on the figure will look like the side that is shown as the right module part 5b on the figure, and similarly the back side of the right module part 5b that not is shown on the figure will look like the left module part 4a shown on the figure. The right module part 4a and the left module part 5b include borings 11 for leading bolts there through holding the module parts and accordingly the modules the needle gripper is built of, together. Furthermore it is shown a curved needle 1 and a curved needle 2 in an extended or protruding position. The curved needles 1 and 2 include a curvature that preferably may be defined as a part of a circle, such that when these are led in a circular path, the needles will create a circular path inside the object that is to be handled. In the left module part 4a it is shown recesses for gaskets 9 and 10 around the curved needle 2. The gaskets 9 and 10 may for instance be O-rings or other seals well known within the field. In the right module part 5b and the left module part 4a it is shown flushing channels 8 between the packers 9 and 10. The flushing channels 8 are provided to flush the needles 1 and 2 between each gripping operation and accordingly retraction and extension of the needles to ensure that the needles are clean, and for maintaining sufficient hygiene.

A piston 7 is shown placed with a dually curved cylinder 6. The dually curved cylinder 6 forms, similarly with the curved needle 2, a part of a circle.

An imagined curved axis through the centre of the curved needle 2 and of the dually curved cylinder 6 preferably forms a segment of the same circle.

The piston 7 may be substantially ball-shaped, but may include a recess in a circumference for a suitable gasket. The outer diameter of the piston 7 is adapted to the inner diameter of the cylinder 6 such that it is created a seal between the gasket of the piston 7 and the cylinder wall. The left module part 4a and the right module part 5b include guides and borings 13, 14 for applying and ventilating pressurized air. The borings 12, 13 and 14 are connected to the cylinders 6 in the modules and ensures actuation of the piston 7 in the cylinder 6 and accordingly for extending and retracting the curved needles 1 and 2. During the application of pressure in boring or channel 12 the curved needle will be led to the extended position (shown on FIG. 2) and by applying a pressure to a channel corresponding to channel 14 (not shown) the curved needle 2 will be led to a retracted position (not shown). Similarly application of a pressure on boring or channel 13 will lead the curved needle 1 outwards, and applying pressurized air to the channel 14, will retract the curved needle 1 back into the right module part 5.

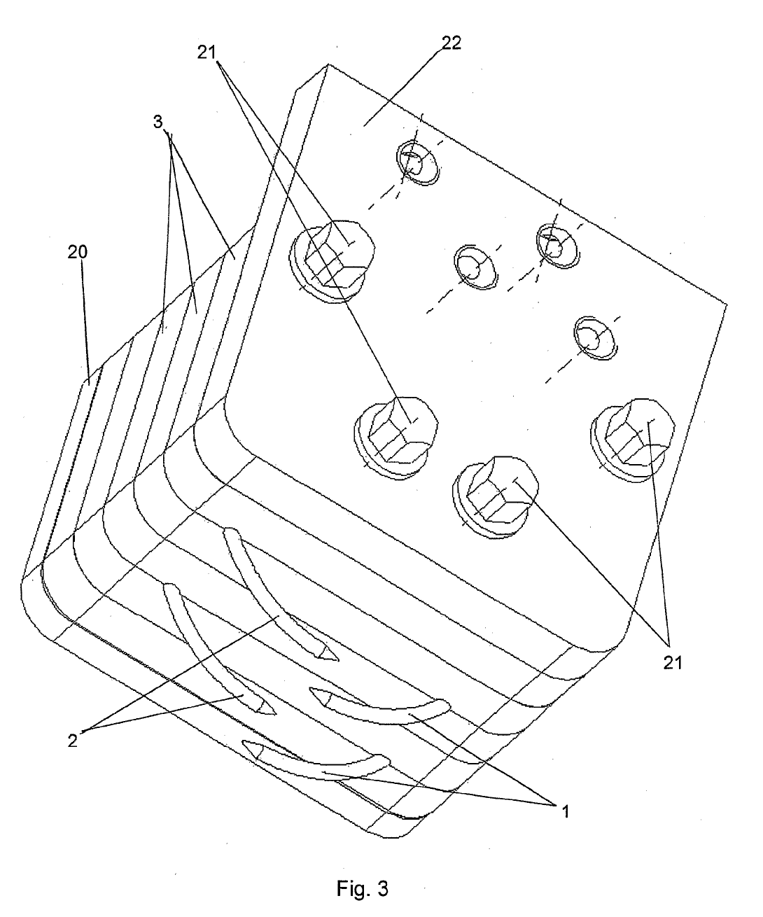

From FIG. 3 it is clearly shown how a needle gripper with four needles 1, 2 may appear from the outside, where the curved needles 1 and 2 are shown in their extended position. The modules of the needle gripper with the housing 3 are clearly shown along with two end pieces 20, 22. Bolts 21 presses the end pieces 20, 22 together, and holds accordingly the modules in position.

The bolts 21 are extending through the needle gripper.

FIG. 4 is an exploded view of a needle gripper according to the other figures, where the various components of the needle gripper are clearly shown. From the right on the figure it is shown an end piece 20 with pin bolts 21 for holding the various components of the needle gripper together.

The bolt 21 goes through the left module parts 4a, 4b and the right module parts 5a, 5b. Adjoining the end pieces 20, 22 it is placed module parts 24, 25 to ensure correct location of the module part.

From FIG. 4 it is shown a curved needle 2 and a substantially ball-shaped piston 7 for being attached to a gasket or sealing ring. The embodiment shown on FIG. 4 includes four needles. Each needle with a respective piston 7 is placed in each module part comprising two parts. On the left side these module parts are shown as 4a and 4b and on the right side these module parts are shown as 5a and 5b. When the two left module parts 4a, 4b are placed together, these parts define the dually curved cylinder. Similarly the two right module parts 5a, 5b defines the dually curved cylinder. The dually curved cylinder may be described as a part of a torus. For each needle 1, 2 the needle gripper is required to have, it is required a unit with a left module part 4, a right module part 5, a curved needle 2 secured to a piston 7 with a gasket, and possibly a between the module part situated packer.

The end parts 24 and 25 ensure an offset position of the needles. Furthermore, as shown on the figure, will each unit include a needle 2 and a piston 7 that is led in a path that defines a plane. Each needle and piston unit will thereby define a path and a plane, and these planes will in the shown embodiment be parallel.

The end piece 22 will also acts as a manifold for application and ventilation of pressurized air through channel 23. The channels 23 are connected to the borings in the module parts. The end piece 22 also serves as a manifold for inlet of flushing liquid in the flushing channels 8 for flushing the needles 2, such that sufficiently hygienic conditions are maintained.

The end piece 20 must also be adapted for handling the fluids that flows through the needle gripper.

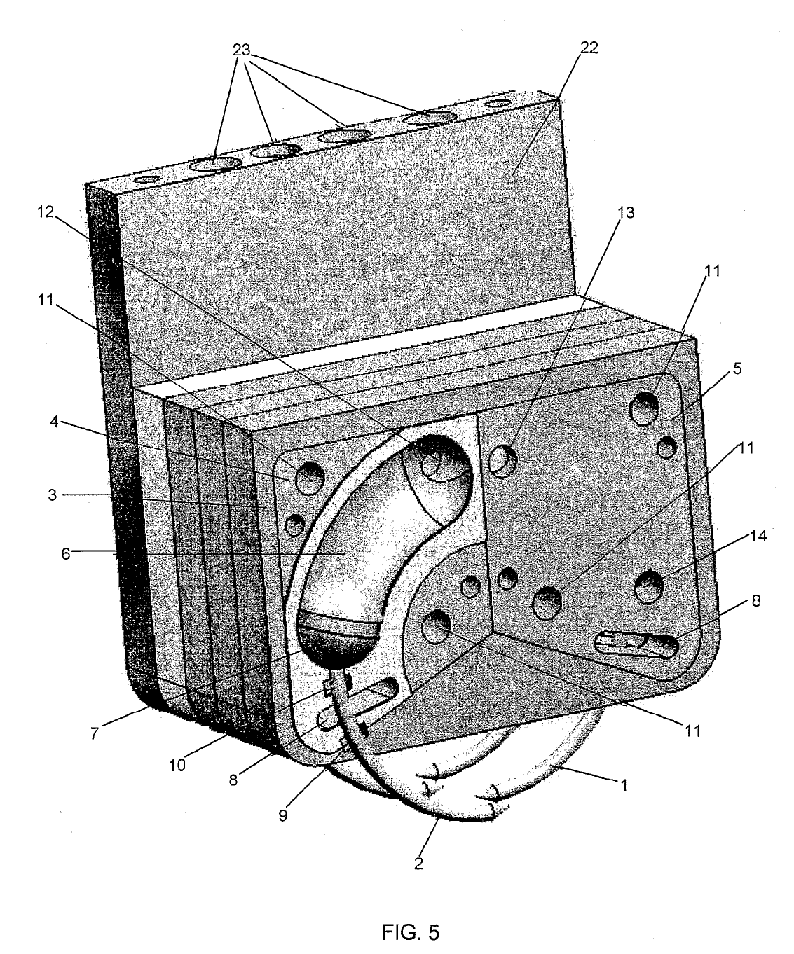

FIG. 5 shows the curved needles 1 and 2 even more clearly. In the shown embodiment the curved needles 1 and 2 are made with a pointed tip to ease insertion of the needle in the object that is to be lifted. FIG. 5 furthermore shows how the needles 1 and 2 are offset in relation to each other, and that they extend somewhat past each other to better secure the object that is to be lifted. However, the needles may be movable in the same plane, and the ends of the needles 1, 2 may point towards each other.

Gaskets 9, 10 around the needle 2 are shown placed in recesses in the housing 3 and in the left module part 4. The gaskets 9, 10 also ensures that the flushing liquid that is led in channel 8 do not flow out of the needle gripper, or into the cylinder 6. The borings 11 are provided for the bolts to hold the needle gripper together. An inlet channel 12, 13 for applying the pressurized air when the needles 1, 2 are to be led out of the needle gripper is shown as borings in the left module part 4 and the right module part 5. Similarly borings for supply or bleeding of pressurized air are shown. Supply of pressurized air to channel 14 will ensure that needle 1 goes to a retracted position. The end piece 22 serves as a manifold for the unit and is shown with borings 23 for supply and bleeding of pressurized air. Channels are also provided for flushing liquid in this unit.

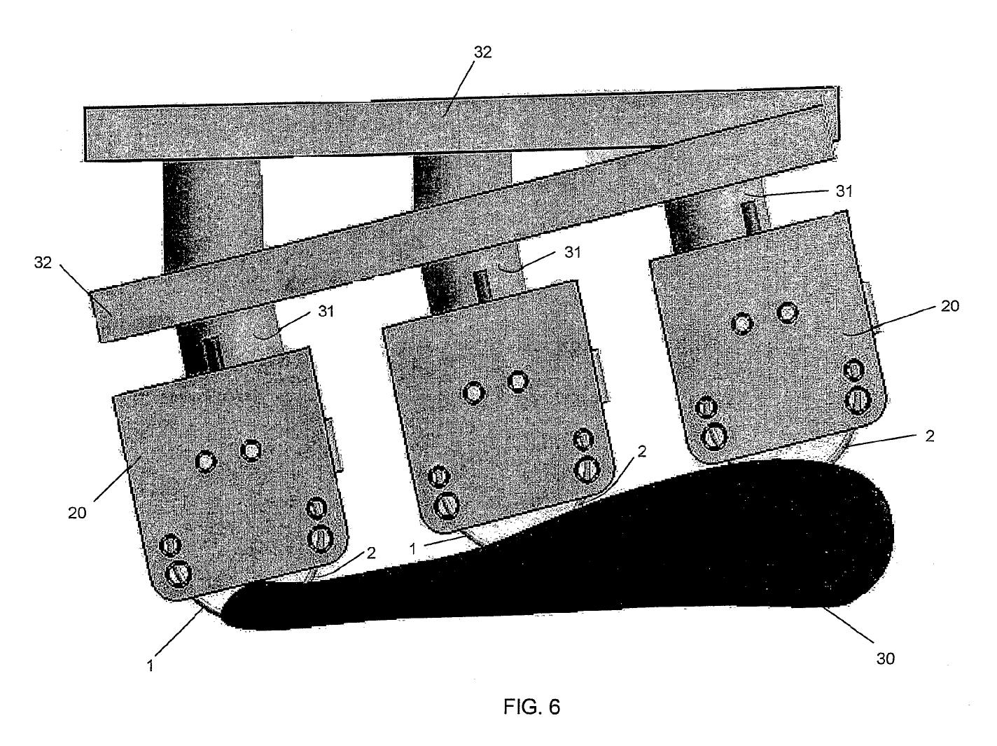

FIG. 6 is a side elevation of an alternative to the apparatus as shown on FIG. 1 where it is shown how the apparatus may be adapted to objects 30 of various shape in that the entire fixing plate 32 is rotated. The end pieces 20 and the needles 1, 2 are clearly shown from the figure. In this embodiment the securing elements 31 may be fixed.

In the enclosed embodiment it is shown two towards each other guided curved needles 1, 2. However it should be possible to use a combination of straight and curved needles. In the shown embodiment the needle tips meets each other approximately on a line when the needles are in an extended position. However one may let the needles travel shorter or longer. How long the needles should extend will depend on the object that is to be lifted and how far it is necessary to extend the needles to get a sufficient grip will vary. The same concerns how many needles that is to be used and, the distance therein between.

The embodiment shows use of a pressure medium to bring the needles back and forth. However there are many mechanisms and objects that may be used to drive the needles back and forth. Such elements may be electric, electromagnetic etc. Furthermore one actuator mechanism may be used to drive several needles.

In the shown embodiment it may appear as if the needles 1, 2 rotate about a common geometric centre. This is however a special condition and the needles do not need to rotate about the same centre, such that the needles 1, 2 both may be closer to each other or further apart.

The needles 1, 2 may also extend further into the object than what is shown such that this “hitches” the object that is to be lifted. It is however important that the motion and location is adapted such that the needles moves and deforms the object that is to be handled as little as possible during gripping and releasing.

1. An apparatus for gripping, holding and releasing articles of food that can be penetrated comprising at least two needles (1, 2) with longitudinal central axes, an actuator connected to the needles (1, 2) to drive these between an extended and a retracted position, where the needles are placed in guides, and where each needle is curved,
characterized in that:
the longitudinal, central axes of the needles forms a part of a circle with geometric central axes;
the needles (1,2) are adapted to be driven between an extended and a retracted position along circular paths defined by the central axis of each needle respectively; and
the needles points towards each other when these are partly or completely extended.

2. The apparatus according to claim 1, wherein at least two of the needles (1, 2) whose axis forms a part of a circle, moves between the extended position and the retracted position along two different paths.

3. The apparatus according to claim 1, wherein at least two needles are in the same plane.

4. The apparatus according to claim 1, wherein each needle (1, 2) are configured in offset planes, and where these planes are parallel.

5. The apparatus according to claim 1, wherein the geometric axes of rotation of the needles are coinciding.

6. The apparatus according to claim 1, further comprising: at least one cylinder (6) with a central axis and a dually curved internal face:
a piston (7) with a dually curved external face placed in each cylinder (6), connected to a needle (1, 2) such that piston (7) and cylinder (6) forms the actuator.

7. The apparatus according to claim 6, where the central axis of at least one of the cylinders (6) is coinciding with the central axis of the at least one needle (1, 2).

8. The apparatus according to claim 6,
wherein each cylinder (6) is designed in a module including at least two module parts (4a, 4b) with parallel, plane sides and borings (12, 13, 14) for leading a pressure medium and where the module parts (4a, 4b) are placed in a housing (3), such that a number of modules corresponding to the number of needles (1, 2) that is to be used may be assembled, side by side with the borings for leading a pressure medium adjacent each other.

9. A gripping element, characterized in that it includes at least two apparatuses according to claim 1, further comprising a plate (32) for being secured to a robot, and a controllable linear actuator (31) for each apparatus secured in each apparatus and in the plate (32) such that the gripping element may be adapted to the shape of an object (30) that is to be lifted.

10. A method for gripping, holding and releasing objects (30) that can be penetrated with an apparatus according to claim 9, characterized in placing the plate (32) for being secured in a robot above the object (30) that is to be handled;
lead the apparatus towards the object (30) that is to be handled;
control the apparatus with the linear actuators (31) adjacent the object (30) that is to be handled;
drive at least two needles (1, 2) from the retracted position to the extended position and into the object (30);
maneuvering the object (30) to a desired position; and
drive at least two needles (1, 2) from the extended position to the retracted position and out of the object (30).

11. The apparatus according to claim 2, further comprising: at least one cylinder (6) with a central axis and a dually curved internal face:
a piston (7) with a dually curved external face placed in each cylinder (6), connected to a needle (1, 2) such that piston (7) and cylinder (6) forms the actuator.

12. The apparatus according to claim 3, further comprising: at least one cylinder (6) with a central axis and a dually curved internal face:
a piston (7) with a dually curved external face placed in each cylinder (6), connected to a needle (1, 2) such that piston (7) and cylinder (6) forms the actuator.

13. The apparatus according to claim 4, further comprising: at least one cylinder (6) with a central axis and a dually curved internal face:
a piston (7) with a dually curved external face placed in each cylinder (6), connected to a needle (1, 2) such that piston (7) and cylinder (6) forms the actuator.

14. The apparatus according to claim 5, further comprising: at least one cylinder (6) with a central axis and a dually curved internal face:
a piston (7) with a dually curved external face placed in each cylinder (6), connected to a needle (1, 2) such that piston (7) and cylinder (6) forms the actuator.

15. The apparatus according to claim 7,
wherein each cylinder (6) is designed in a module including at least two module parts (4a, 4b) with parallel, plane sides and borings (12, 13, 14) for leading a pressure medium and where the module parts (4a, 4b) are placed in a housing (3), such that a number of modules corresponding to the number of needles (1, 2) that is to be used may be assembled, side by side with the borings for leading a pressure medium adjacent each other.

16. A gripping element, characterized in that it includes at least two apparatuses according to claim 2, further comprising a plate (32) for being secured to a robot, and a controllable linear actuator (31) for each apparatus secured in each apparatus and in the plate (32) such that the gripping element may be adapted to the shape of an object (30) that is to be lifted.

17. A gripping element, characterized in that it includes at least two apparatuses according to claim 3, further comprising a plate (32) for being secured to a robot, and a controllable linear actuator (31) for each apparatus secured in each apparatus and in the plate (32) such that the gripping element may be adapted to the shape of an object (30) that is to be lifted.

18. A gripping element, characterized in that it includes at least two apparatuses according to claim 4, further comprising a plate (32) for being secured to a robot, and a controllable linear actuator (31) for each apparatus secured in each apparatus and in the plate (32) such that the gripping element may be adapted to the shape of an object (30) that is to be lifted.

19. A gripping element, characterized in that it includes at least two apparatuses according to claim 5, further comprising a plate (32) for being secured to a robot, and a controllable linear actuator (31) for each apparatus secured in each apparatus and in the plate (32) such that the gripping element may be adapted to the shape of an object (30) that is to be lifted.

20. A gripping element, characterized in that it includes at least two apparatuses according to claim 6, further comprising a plate (32) for being secured to a robot, and a controllable linear actuator (31) for each apparatus secured in each apparatus and in the plate (32) such that the gripping element may be adapted to the shape of an object (30) that is to be lifted.
